(19) United States
(12) Patent Application Publication
(10) Pub. No.: US 2018/0285562 A1
(43) Pub. Date: Oct. 4, 2018

(54) COMPUTING SYSTEM WITH PROTECTION AGAINST MEMORY WEAR OUT ATTACKS

(71) Applicant: Intel Corporation, Santa Clara, CA (US)

(72) Inventors: Sivakumar Radhakrishnan, Portland, OR (US); Mahesh S. Natu, Sunnyvale, CA (US); Pawel Szymanski, Gdansk (PL); Zhenyu Zhu, Folsom, CA (US); Malay Trivedi, Chandler, AZ (US); Kirk D. Brannock, Hillsboro, OR (US); Geoffrey S. Strongin, Beaverton, OR (US)

(73) Assignee: Intel Corporation, Santa Clara, CA (US)

(21) Appl. No.: 15/476,196

(22) Filed: Mar. 31, 2017

(51) Int. Cl. G06F 21/55; G11C 16/34; G11C 16/16; G06F 3/06

(52) U.S. Cl. CPC G06F 21/554; G11C 16/3495; G11C 16/16; G06F 2221/034; G06F 3/0653; G06F 3/0659; G06F 3/0679; G06F 3/0619

(57) ABSTRACT

Technology for a computing system is described. The computing system can include memory, a controller, and a security management module. The controller can receive a block erase command for erasing data stored in a block of memory. The controller can store information associated with the block erase command in a store, wherein the information includes a block address associated with the data to be erased based on the block erase command. The security management module can read block addresses from the store, update a block erase count array over a defined interval to include block addresses read from the store, compare the block erase count array to a defined threshold, identify block addresses for which the block erase count array is above the defined threshold, and deny subsequent block erase commands for the identified block addresses.

### BACKGROUND

Non-volatile memory cells, such as flash memory cells, can wear out and degrade over time due to repeated program/erase processes for programming/writing and erasing data on the non-volatile memory cells. When certain types of non-volatile memory cells are programmed with new data, the memory cells can be erased before the new data is programmed. Flash memory cells, for example, use a series of floating-gate transistors to store charge for an extended period of time. An oxide layer can insulate the floating-gate transistors and trap electrons, which can control a threshold voltage of the floating-gate transistors utilized for programming and erasing data on the non-volatile memory cells. The program/erase processes can gradually deteriorate the oxide layer insulating the floating-gate transistors over time, thereby causing the non-volatile flash memory cells to degrade and become unreliable.

Typically, non-volatile memory devices are rated to guarantee a defined number of program/erase cycles before the memory cells in such devices start to degrade. As one example, a non-volatile memory device with single-level cell (SLC) non-volatile memory can be rated for 100,000 program/erase cycles, and a non-volatile memory device with a multi-level cell (MLC) non-volatile memory can be rated for 10,000 program/erase cycles. In this example, the 100,000 program/erase cycles can be over a 10 year lifetime, which translates to approximately 1.14 erases per hour.

### BRIEF DESCRIPTION OF THE DRAWINGS

Features and advantages of invention embodiments will be apparent from the detailed description which follows, taken in conjunction with the accompanying drawings, which together illustrate, by way of example, invention features; and, wherein:

FIG. 1 illustrates a system and related operations for protecting against non-volatile memory wear out attacks in accordance with an example embodiment;

FIG. 2 illustrates a computing system operable to protect against memory wear out attacks in accordance with an example embodiment;

FIG. 3 illustrates an apparatus operable to protect against memory wear out attacks in accordance with an example embodiment;

FIG. 4 depicts a flowchart of a method for protecting a non-volatile memory against a memory wear out attack in accordance with an example embodiment; and

FIG. 5 illustrates a computing system that includes a data storage device in accordance with an example embodiment.

Reference will now be made to the exemplary embodiments illustrated, and specific language will be used herein to describe the same. It will nevertheless be understood that no limitation on invention scope is thereby intended.

### DESCRIPTION OF EMBODIMENTS

Before the disclosed invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various invention embodiments. One skilled in the relevant art will recognize, however, that such detailed embodiments do not limit the overall inventive concepts articulated herein, but are merely representative thereof.

Reference throughout this specification to “an example” means that a particular feature, structure, or characteristic described in connection with the example is included in at least one embodiment of the present invention. Thus, appearances of the phrases “in an example” or “an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

An initial overview of technology embodiments is provided below and then specific technology embodiments are described in further detail later. This initial summary is intended to aid readers in understanding the technology more quickly, but is not intended to identify key or essential technological features nor is it intended to limit the scope of the claimed subject matter. Unless defined otherwise, all technical and scientific terms used herein have the same meaning as commonly understood by one of ordinary skill in the art to which this disclosure belongs.

Non-volatile memory cells wear out and degrade over time due to the normal program/erase processes for programming/writing and erasing data on the non-volatile memory cells. NAND flash non-volatile memory cells, for example, use a series of floating-gate transistors to store charge for an extended period of time. An oxide layer is utilized to insulate the floating-gate transistors and trap electrons, which can control a threshold voltage of the floating-gate transistors utilized for programming and erasing data on the non-volatile memory cells. Program/erase processes in general tend to gradually deteriorate the oxide layer over time during normal use, thereby degrading the floating-gate transistor in the memory cell, leading to unreliability and/or failure.

This tendency of wearing over time can be exploited, by a hacker or other malicious party or individual, in attacks against non-volatile memories in various computers, computer systems, server and networked systems, and the like. In one such example known as a non-volatile memory wear out attack, a malicious attacker deliberately performs an excessive number of program and erase requests on non-volatile memory in an attempt to render the memory or the associated system inoperable. These program and erase requests cause an excessive number of program and erase operations to be performed on the targeted non-volatile memory. Such an unduly large number of program and erase operations can speed up the wear experienced by the non-volatile memory, thus causing the non-volatile memory to degrade, become unreliable, or even fail all together. Wear out attacks can greatly increase the wear on a non-volatile memory beyond what is expected under normal operations, thus causing unreliability and/or failure that is premature. For example, programming and erasing data can become more unreliable as the non-volatile memory starts to wear and degrade. The memory can subsequently degrade to the point of failure, and, if the attack is directed to a system-critical non-volatile memory, such as system firmware, to the point of system failure. As such, non-volatile memory wear out attacks can cause a permanent denial of service (pDOS) in an affected system, and a loss of functionality of the non-volatile memory.

A scalable and secure non-volatile memory wear out protection scheme is described herein. The non-volatile memory wear out protection scheme can protect non-volatile memory in a computing system against brute force or other directed non-volatile memory wear out attacks, which can degrade the non-volatile memory and/or render the non-volatile memory inoperable. The non-volatile memory wear out protection scheme can achieve security protection by stopping or mitigating a malicious attacker's attempt to destroy or freeze the non-volatile memory. As a non-limiting example, the non-volatile memory can include serial peripheral interface (SPI) non-volatile memory, which is often used in clients and/or servers as firmware storage.

In one configuration, the non-volatile memory wear out protection scheme can provide a number of benefits. For example, the non-volatile memory wear out protection scheme can inhibit or curtail processors that issue malicious back-to-back erase commands for a single block of non-volatile memory, which may exceed a maximum level of anticipated use. The non-volatile memory wear out protection scheme can also track and mitigate an excessive number of erase commands that occur in a randomized manner (i.e., not back-to-back erase commands), as well as an excessive number of erase commands that occur in a certain pattern (e.g., erase commands received in regular intervals, irregular intervals, or any random or pseudorandom pattern). The non-volatile memory wear out protection scheme can prevent or block an agent that maliciously directs network firmware, such as network interface controller (NIC) firmware, to perform repeated updates to a NIC. These repeated updates can involve repeated program/erase processes, thereby degrading the non-volatile memory and/or rendering the non-volatile memory inoperable over time.

As discussed in further detail below, the non-volatile memory wear out protection scheme can utilize a controller (e.g., a SPI controller) and a security management module (e.g., a converged security and management engine (CSME)) in a computing node. The controller can store information associated with block erase commands received from a processor to erase blocks of data stored in a non-volatile memory. The information can be stored in a store, such as a first-in first-out (FIFO) register. The information can include a block address associated with the data to be erased based on the block erase command. The security management module can read block addresses from the store, and update a block erase count array over a defined interval to include block addresses read from the store. The security management module can compare the block erase count array to a defined threshold on a per-block basis. The defined threshold can be dynamically configured using various heuristics, specific attack patterns or attack vectors, risk levels of wear out attacks on specific blocks in the non-volatile memory, a current mode of operation for the non-volatile memory, etc. Therefore, in some cases the non-volatile memory wear out protection scheme can be fine-tuned based on evolving security threat conditions. For example, when block addresses are identified for which the block erase count array is above the defined threshold, the security management module can deny subsequent block erase commands for the block addresses for a defined period of time, thereby protecting the non-volatile memory against further non-volatile memory wear out attacks. In some examples, the security management module can enable and disable subsequent block erase commands on a per-block basis, or any other size of erasable region for which a wear out attack can be detected.

In one example, the non-volatile memory wear out protection scheme can involve monitoring an erase activity in real time using a block/sector erase monitoring mechanism (e.g., 4K-byte erases). The non-volatile memory wear out protection scheme can determine when an erase activity rate or pattern violates a preconfigured threshold. For example, when the erase activity rate is above the preconfigured threshold, the security management module can notify the controller to block subsequent erase commands, thereby protecting the non-volatile memory. The non-volatile memory wear out protection scheme can be transparent and agnostic to a wear out attack pattern. For example, the non-volatile memory wear out protection scheme can protect the non-volatile memory against sequential vector attacks (an attack spread out over time according to one or more intervals) and/or bursty vector attacks (an attack that is back-to-back) on one or more regions or blocks within the non-volatile memory over a given time interval. Additionally, the wear out protection scheme protects against a combination of sequential vector and bursty vector attacks, where attacks can occur in a series of bursts over time. The non-volatile memory wear out protection scheme can be agnostic with respect to any specific processor (or master) that can repeatedly erase and freeze the non-volatile memory.

In one configuration, the non-volatile memory wear out protection scheme can be advantageous over a full hardware based erase monitoring scheme, which can track erases per non-volatile memory block for all regions in an on-die or off-die storage. However, a full hardware based erase monitoring scheme can be prohibitively expensive, consume an increased amount of power, and not scale favorably when additional non-volatile memory is added to the computing system. For example, increasing the non-volatile memory in a full hardware based erase monitoring scheme can involve increasing a size of an erase tracking array, which can entail modifying the hardware. The modification of hardware can be cumbersome, and if not performed, a user can have a compromised non-volatile memory wear out scheme. In addition, a full hardware based erase monitoring scheme may not be modifiable when targeting a specific attack pattern or attack vector. In other words, a full hardware based erase monitoring scheme cannot be reconfigured when attack patterns or attack vectors change, which can be disadvantageous because hackers are likely to change their attack strategies over time. Another disadvantage of a full hardware-based erase monitoring scheme is that a threshold for excessive erase detection can be statically configured by a system vendor, and thus may not dynamically account for changing conditions. The non-volatile memory wear out protection scheme, which provides a combination of hardware and software support, does not suffer the same disadvantages as a full hardware based erase monitoring scheme.

In other alternative solutions, a field programmable gate array (FPGA) or complex programming logic device (CPLD) designs can mitigate against a number of attacks against non-volatile memory devices. In these designs, secure non-volatile random access memory (NVRAM) storage can be utilized for tracking purposes. The NVRAM storage can reside outside a non-volatile memory that is being protected (e.g., inside the FPGA/CPLD). Although these designs can provide a robust protection against non-volatile memory attacks, an increased cost and additional discrete components can be burdensome.

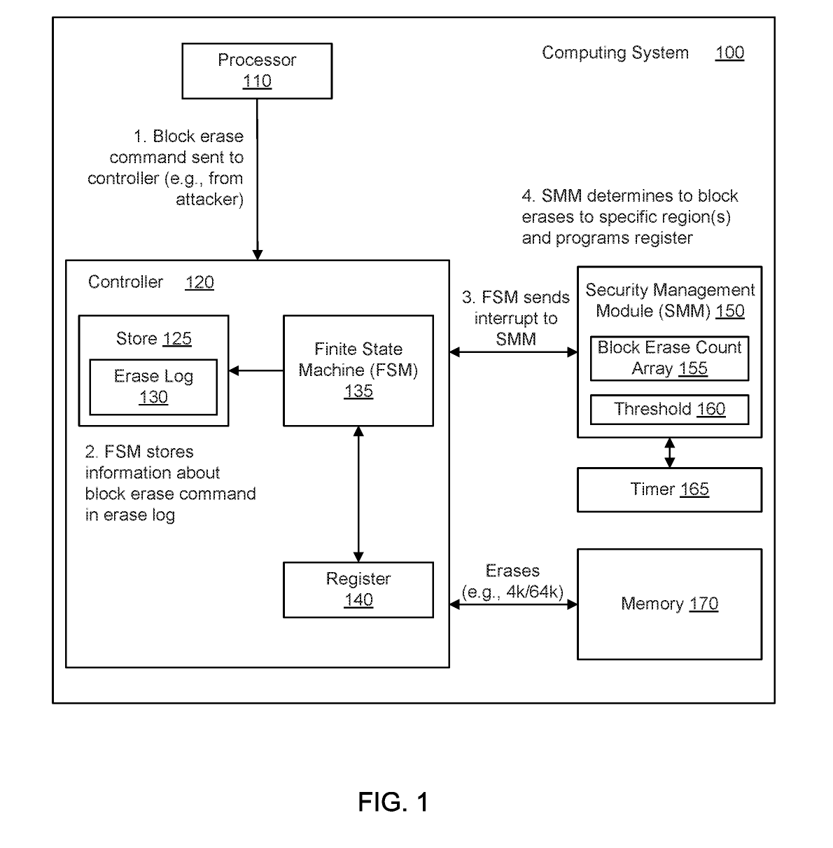

FIG. 1 illustrates an exemplary computing system 100 operable to protect against non-volatile memory wear out attacks that avoids many of the above-mentioned issues. The computing system 100 can implement a non-volatile memory wear out protection scheme to protect against non-volatile memory attacks. The computing system 100 can include a processor 110, such as a central processing unit (CPU). The processor 110 can be communicatively coupled to a controller 120 in the computing system 100. As a non-limiting example, the controller 120 can be a SPI controller. The controller 120 can be communicatively coupled to a security management module 150 in the computing system 100. As a non-limiting example, the security management module 150 can be a CSME or a baseboard management controller (BMC). The controller 120 can program/write data to memory 170 in the computing system 100, and the controller 120 can read data from the memory 170 in the computing system 100.

In one example, the memory 170 can include non-volatile memory. Non-volatile memory is a storage medium that does not require power to maintain the state of data stored by the medium. Non-limiting examples of non-volatile memory can include any or a combination of solid state memory (such as planar or three-dimensional (3D) NAND flash memory, NOR flash memory, or the like), cross point array memory, including 3D cross point memory, phase change memory (PCM), such as chalcogenide PCM, non-volatile dual in-line memory module (NVDIMM), ferroelectric memory (FeRAM), silicon-oxide-nitride-oxide-silicon (SONOS) memory, polymer memory (e.g., ferroelectric polymer memory), ferroelectric transistor random access memory (Fe-TRAM), spin transfer torque (STT) memory, nanowire memory, electrically erasable programmable read-only memory (EEPROM), magnetic storage memory, magnetoresistive random-access memory (MRAM), write in place non-volatile MRAM (NVMRAM), nanotube RAM (NRAM), and the like. These types of non-volatile memory may be byte or block addressable. In some examples, non-volatile memory can comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org). In one specific example, the system memory can be NAND flash. In another specific example, the system memory can be 3D cross point memory.

In one configuration, the processor 110 (also known as a master) can send a block erase command to the controller 120. The block erase command can be for erasing data stored in a block of the memory 170. In some cases, the block erase command received from the processor 110 can be initiated by a malicious attacker attempting to wear out the memory 170 in the computing system 100. The controller 120 can check a register 140 (e.g., a “WO_BLOCK_EN” register) upon receiving the block erase command, and when the register 140 does not indicate that erases to that particular block or region (i.e., corresponding to the block erase command) are prohibited, the controller 120 can schedule the erase corresponding to the block erase command received from the processor 110.

In one example, the controller 120 can carry out the block erase command by erasing data stored in the memory 170 in accordance with the block erase command. More specifically, the controller 120 can erase data stored in a particular block or sector or region in the memory 170 in accordance with the block erase command.

As a non-limiting example, the controller 120 can support programming/erasing data in 4K-byte blocks or sectors or regions in the memory 170. In other words, the controller 120 can support a granularity as low as 4K-bytes when performing programming/erasing operations. In some examples, the controller 120 can perform programming/erasing operations with a granularity of 64K-bytes (i.e., data is programmed/erased in 64K-byte blocks or sectors or regions in the memory 170).

In one example, in addition to performing the block erase command, the controller 120 can store information associated with block erase commands in a store 125 within the controller 120. The controller 120 can utilize a finite state machine (FSM) 135 when storing the information associated with the block erase commands. As an example, the store 125 can be a first-in first-out (FIFO) register. The store 125 can maintain an erase log 130 of the information associated with block erase commands that are received at the controller 120. The information for each block erase command can include: a block address associated with the data to be erased based on the block erase command, an erase type, and a region number of the memory 170 in which the block erase command occurs. The erase log 130 can be an N-entry log of block addresses, erase types and region numbers associated with block erase commands that are received at the controller 120, where N is a positive integer and indicates a depth of the erase log 130. The erase log 130 can be implemented as a circular array. For example, when N is equal to 16, the erase log 130 can be implemented as a 16×32-bit circular array. Therefore, the FSM 135 in the controller 120 can record or log information about each received block erase command (e.g., block address, erase type and region number) in the erase log 130 of the store 125 (e.g., FIFO register). Each entry in the erase log 130 (which can be implemented as a circular array) of the store 125 (e.g., FIFO register) can be accessible using a head/tail pointer. In one example, the controller 120 can provide a memory-mapped input-output (MIMO) space availability to the security management module 150 in order to access the erase log 130. While the controller 120 can include the erase log 130, the security management module 150 can manipulate the erase log 130 and write changes back into the erase log 130

In one example, when the erase log 130 has run out of space to store information about block memory commands, this is considered as a possible error condition. In this scenario, the controller 120 may not schedule any additional erases until the possible error condition is handled by the security management module 150. This can prevent a malicious attacker from launching a denial of service (DoS) attack on the security management module 150 to fill up the erase log 130 in order to bypass the wear out protection. If the controller 120 continued to schedule erases, the malicious attacker could perform a wear out attack before the security management module 150 freed up space in the erase log 130. In addition, the controller 120 can send an interrupt to the security management module 150 indicating that the erase log 130 is full and cannot store additional information about block memory commands.

In one example, after receiving the block erase command from the processor 110 and storing information about the block erase command in the erase log 130 of the store 125, the controller 120 can send an erase interrupt to the security management module 150. An erase interrupt threshold register can be set to reduce or otherwise minimize a number of erase interrupts that are sent from the controller 120. The number of erase interrupts sent from the controller 120 can be reduced to help prevent the security management module 150 from unnecessarily servicing the non-volatile memory wear out protection scheme, which can save power and restore bandwidth useful for other applications, as a computational capacity of the security management module 150 can be limited.

In response to receiving the erase interrupt from the controller 120, the security management module 150 can probe or access the erase log 130 in the store 125 (e.g., FIFO register). The security management module 150 can copy the information in the erase log 130 into a local memory of the security management module 150. The security management module 150 can read the information that is copied to the local memory of the security management module 150. More specifically, the security management module 150 can read valid block addresses included in the information.

In one example, after reading the valid block addresses included in the information, the security management module 150 can update a block erase count array 155 based on the block addresses included in the information. The block erase count array 155 may be locally stored in the security management module 150. The block erase count array 155 can be a listing of all block addresses in the memory 170 for which an erase was performed over a defined period of time. The block erase count array 155 can indicate when erases are performed multiple times on the same block addresses in the memory 170. A size of the block erase count array 155 can depend on a size of the memory 170. As a non-limiting example, when the memory 170 is 128 megabytes (MB), with a 4K-byte erase block or sector or region, the block erase count array 155 can utilize 32 kilobytes (kB) of local memory in the security management module 150.

In one example, after processing the information copied from the erase log 130 into the local memory of the security management module 150, the security management module 150 can clear locations in the store 125 (e.g., FIFO locations) which contained valid data, such as the valid block addresses. In other words, after the security management module 150 updates the block erase count array 155 using the information extracted from the erase log 130, the information has served its purpose and the security management module 150 can clear this information from the erase log 130. By clearing the erase log 130 of now irrelevant information, the controller 120 can add entries for subsequent block erase commands in the erase log 130. The store 125 can have a special attribute that is cleared by the security management module 150 after the valid data is read from the erase log 130 in the store 125.

In one example, the security management module 150 can update the block erase count array 155 over a defined period of time in accordance with a timer 165. In other words, the security management module 150 can track a block erase rate over the defined period of time in accordance with the timer 165. As a non-limiting example, the security management module 150 can track the block erase rate by updating the block erase count array 155 in one-hour intervals (i.e., the timer 165 can run for one hour). After the timer 165 expires (e.g., after one hour), the timer 165 can restart and the security management module 150 can again start tracking the block erase rate in accordance with the timer 165. In this non-limiting example, the one-hour interval can be selected based on a lifetime erase metric for the memory 170.

In one configuration, the security management module 150 can compare the block erase count array 155 to a threshold 160. The block erase count array 155 can compare the block erase count array 155 to the threshold 160 on a per-block basis, a per-sector basis, a per-region basis, or the like. When the security management module 150 determines that the block erase count array 155 is below the threshold 160, the security management module 150 may perform no actions. On the other hand, when the security management module 150 determines that the block erase count array 155 meets or exceeds the threshold 160, the security management module 150 can prohibit subsequent erases to a corresponding block or sector or region. In other words, based on a comparison of the block erase count array 155 to the threshold 160, the security management module 150 can identify block addresses for which the block erase count array 155 is above the threshold 160, and then the security management module 150 can deny subsequent block erase commands for these block addresses.

As a result, the memory 170 can be protected against non-volatile memory wear out attacks since a malicious attack that involves an excessive number of block erase commands to the same block or sector or region (or a suspicious pattern of block erase commands to the same block or sector or region) can be detected based on the comparison of the block erase count array 155 to the threshold 160, and then the malicious attack can be mitigated by preventing subsequent erases on that block or sector or region. Thus, ongoing malicious attacks can be detected and protective measures can be taken to mitigate the malicious attacks, which can serve to protect the memory 170 from wear out over time.

In one example, based on the comparison of the block erase count array 155 to the threshold 160, the security management module 150 can prohibit subsequent erases to the corresponding block or sector or region for a defined duration. The defined duration can correspond to a timer interval counter. In other words, the security management module 150 can prohibit subsequent erases to the corresponding block or sector or region for a duration of the timer interval counter. When the timer interval counter rolls over, the security management module 150 can clear all locations of the block erase count array 155 in its local memory, and the security management module 150 can permit erases to all blocks or sectors or regions in the memory 170.

In one example, the security management module 150 can prohibit subsequent erases to the corresponding block or sector or region by setting the register 140 (e.g., the “WO_BLOCK_EN” register). The security management module 150 can set a bit in the register 140 to disable erases for the corresponding block or sector or region. In other words, the security management module 150 can set the bit in the register 140 to disable erases to the block address for which the block erase count array 155 is above the threshold 160. After the duration of the timer interval counter, erases for the corresponding block or sector or region can be enabled.

In one configuration, the threshold 160 can be a dynamic threshold or parameter that is configured by the security management module 150. For example, the threshold 160 can be dynamically configured using heuristics, past historical statistics, or the like. The threshold 160 can be dynamically configured based on a defined wear out attack pattern or a defined wear out attack vector. The threshold 160 can be dynamically configured for specific blocks in the memory 170 based on a risk level of wear out attacks on the specific blocks in the memory 170. For example, certain blocks or sectors or regions in the memory 170 can be more vulnerable to malicious attacks, and these areas of the memory 170 can be assigned a weighted priority when configuring the threshold 160. The threshold 160 can be dynamically configured depending on a current mode of operation for the memory 170. For example, based on a lifetime erase decay of the memory 170, a number of permissible erases for a given block or sector or region can be set to “one per hour” as a nominal quota, but an increased number of erases for a given block or sector or region can be desired (e.g., four erases per hour) during critical operations (e.g., high priority operations) of the given block or sector or region. In this case, the threshold 160 can be dynamically adjusted based on the current mode of operation, such that the increased number of erases for a given block or sector or region does not trigger a violation. The ability to dynamically configure the threshold 160 based on the heuristics, attack vector, etc. (as opposed to having a fixed threshold) can result in a number of advantages over a fixed hardware implementation.

In one example, the threshold 160 can be a predetermined pattern threshold (e.g., based on past historical statistics), in which the predetermined pattern threshold can be a degree of correlation between an erase pattern and a pattern threshold that was predetermined to be suspicious. In this example, the security management module 150 can compare an erase pattern extracted from the block erase count array 155 to the predetermined pattern threshold, and based on the comparison, the security management module 150 can infer that the erase pattern is likely an indication of a wear out attack. In this example, subsequent erases can be blocked due to suspicious erase patterns as opposed to a total number of erases in a block or region.

In one example, a malicious hacker can obtain permission to access a certain region, such as a Basic Input/Output System (BIOS) region by compromising certain hardware, such as a NIC. However, even though the malicious attacker can obtain permission to access the certain region to potentially launch a malicious attack (e.g., a bursty attack or an attack spread out over an interval), the malicious hacker can be blocked once the threshold 160 is crossed.

In one example, in addition to being utilized for the non-volatile memory wear out protection scheme, the security management module 150 can provide additional capabilities. For example, the security management module 150 can provide remote access to erase statistics and early memory wear out notifications. In another example, when the block erase count array 155 does not exceed the threshold 160 on a per-block or per-sector or per-region basis, the security management module 150 may not process each block erase command that is received at the controller 120, which can ensure that erases are not delayed if the security management module 150 is busy when the processor 110 (or master) issues a block erase command.

In one example, when erases to a given block or sector or region is prohibited, the controller 120 can prevent the FSM 135 from proceeding further (e.g., storing information in the erase log 130), and the controller 120 can perform error logs. For example, the controller 120 can log error events in a register. The processor 110 (e.g., a region master) can read the register/logs and determine subsequent actions to perform. In one example, the processor 110 (e.g., a region master) can clear the log error events and program new subsequent transactions (e.g., read or write operations).

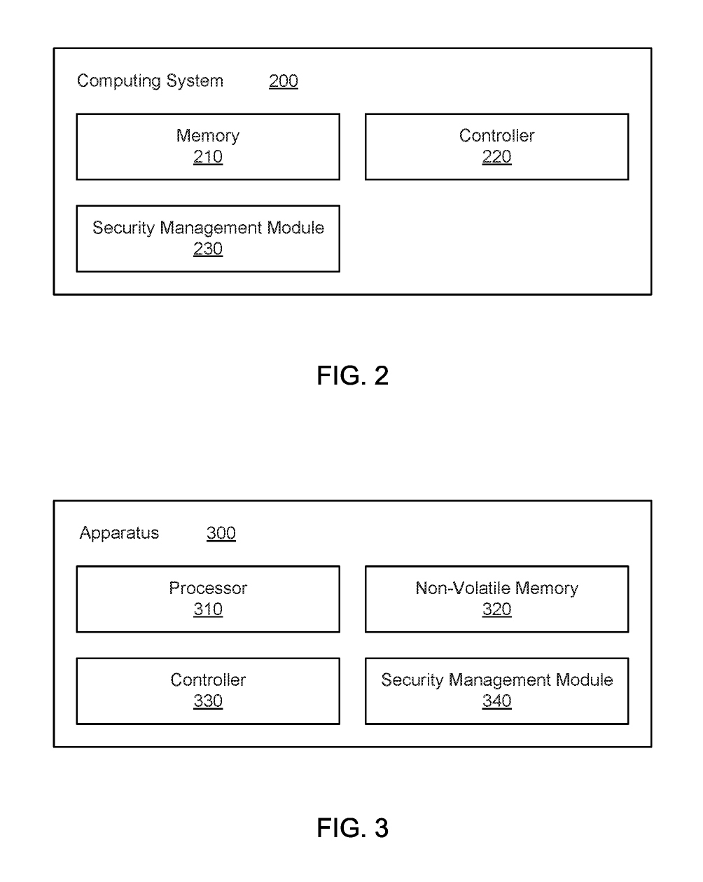

FIG. 2 illustrates a computing system 200 operable to protect against memory wear out attacks. The computing system 200 can include memory 210, a controller 220 and a security management module 230. The controller 220 can receive a block erase command for erasing data stored on a block of memory. The controller 220 can store information associated with the block erase command in a store. The information can include a block address associated with the data to be erased based on the block erase command. The security management module 230 can read block addresses from the store. The security management module 230 can update a block erase count array over a defined interval to include block addresses read from the store. The security management module 230 can compare the block erase count array to a defined threshold on a per block basis. The security management module 230 can identify block addresses for which the block erase count array is above the defined threshold. The security management module 230 can deny subsequent block erase commands for the block addresses, thereby protecting the memory 210 against memory wear out attacks.

FIG. 3 illustrates an apparatus 300 operable to protect against memory wear out attacks. The apparatus 300 can include a processor 310, non-volatile memory 320, a controller 330 and a security management module 340. The controller 330 can receive, from the processor 310, a block erase command for erasing data stored on a block of non-volatile memory 320. The controller 330 can store information associated with the block erase command in a store. The information can include a block address associated with the data to be erased based on the block erase command. The security management module 340 can receive an erase interrupt from the controller 330. The security management module 340 can read block addresses from the store upon receiving the erase interrupt. The security management module 340 can update a block erase count array over a defined interval to include block addresses read from the store. The security management module 340 can compare the block erase count array to a defined threshold on a per block basis. The security management module 340 can identify block addresses for which the block erase count array is above the defined threshold. The security management module 340 can deny subsequent block erase commands for the block addresses for a defined period of time, thereby protecting the non-volatile memory 320 against memory wear out attacks.

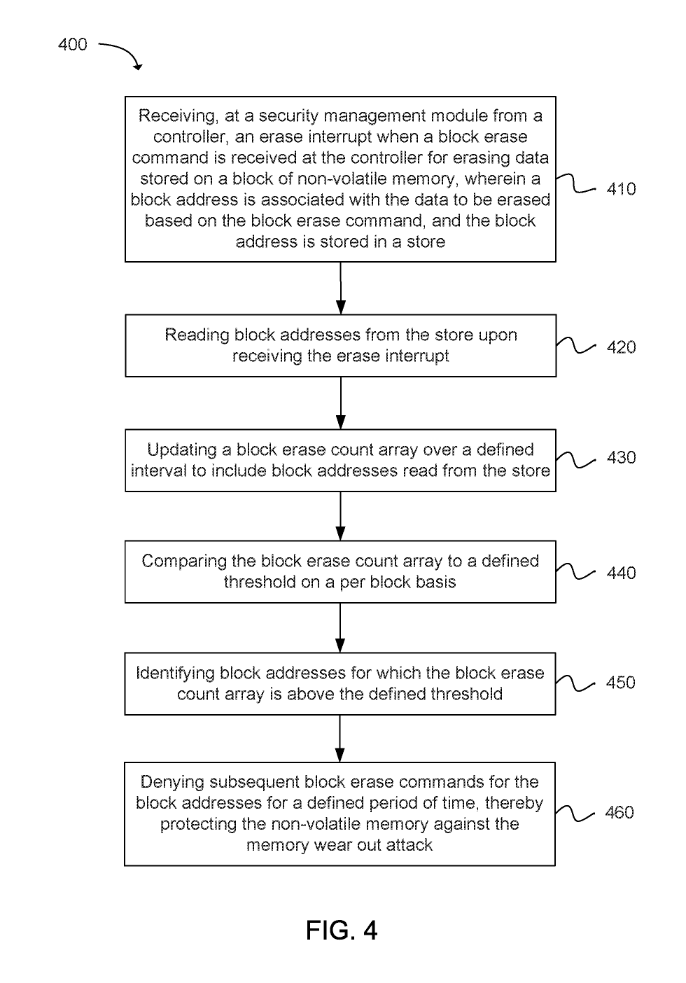

Another example provides a method 400 for protecting a non-volatile memory against a memory wear out attack, as shown in the flow chart in FIG. 4. The method can be executed as instructions on a machine, where the instructions are included on at least one computer readable medium or at least one non-transitory machine readable storage medium. The method can include the operation of: receiving, at a security management module from a controller, an erase interrupt when a block erase command is received at the controller for erasing data stored on a block of non-volatile memory, wherein a block address is associated with the data to be erased based on the block erase command, and the block address is stored in a store, as in block 410. The method can include the operation of: reading block addresses from the store upon receiving the erase interrupt, as in block 420. The method can include the operation of: updating a block erase count array over a defined interval to include block addresses read from the store, as in block 430. The method can include the operation of: comparing the block erase count array to a defined threshold on a per block basis, as in block 440. The method can include the operation of: identifying block addresses for which the block erase count array is above the defined threshold, as in block 450. The method can include the operation of: denying subsequent block erase commands for the block addresses for a defined period of time, thereby protecting the non-volatile memory against the memory wear out attack, as in block 460.

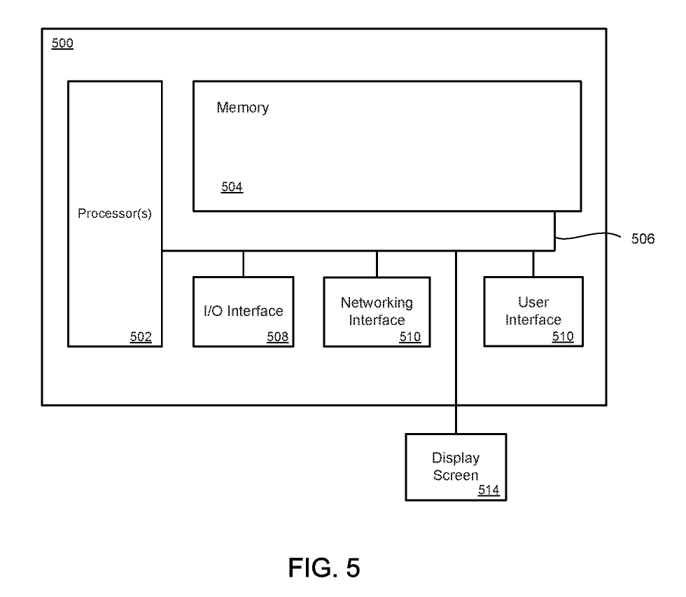

FIG. 5 illustrates a general computing system or device 500 that can be employed in the present technology. The computing system 500 can include a processor 502 in communication with a memory 504. The memory 504 can include any device, combination of devices, circuitry, and the like that is capable of storing, accessing, organizing and/or retrieving data. Non-limiting examples include SANs (Storage Area Network), cloud storage networks, volatile or non-volatile memory, phase change memory, optical media, hard-drive type media, and the like, including combinations thereof.

The computing system or device 500 additionally includes a local communication interface 506 for connectivity between the various components of the system. For example, the local communication interface 506 can be a local data bus and/or any related address or control busses as may be desired.

The computing system or device 500 can also include an I/O (input/output) interface 508 for controlling the I/O functions of the system, as well as for I/O connectivity to devices outside of the computing system 500. A network interface 510 can also be included for network connectivity. The network interface 510 can control network communications both within the system and outside of the system. The network interface can include a wired interface, a wireless interface, a Bluetooth interface, optical interface, and the like, including appropriate combinations thereof. Furthermore, the computing system 500 can additionally include a user interface 512, a display device 514, as well as various other components that would be beneficial for such a system.

The processor 502 can be a single or multiple processors, and the memory 504 can be a single or multiple memories. The local communication interface 506 can be used as a pathway to facilitate communication between any of a single processor, multiple processors, a single memory, multiple memories, the various interfaces, and the like, in any useful combination.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations. Exemplary systems or devices can include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

### EXAMPLES

The following examples pertain to specific invention embodiments and point out specific features, elements, or steps that can be used or otherwise combined in achieving such embodiments.

In one example there is provided a computing system comprising memory and a controller configured to receive a block erase command for to erase data stored in a block of memory, and to store information associated with the block erase command in a store. The information includes a block address associated with the data to be erased based on the block erase command. The computing system further comprises a security management module configured to read block addresses from the store, update a block erase count array stored in the security management module over a defined interval to include block addresses read from the store, compare the block erase count array to a defined threshold on a per block basis, identify block addresses for which the block erase count array is above the defined threshold, and deny subsequent block erase commands for the identified block addresses to protect the memory against memory wear out attacks.

In one example of a computing system, the security management module is further configured to allow subsequent block erase commands after a defined period of time in accordance with a timer interval counter, and remove one or more block addresses from the block erase count array.

In one example of a computing system, the security management module is further configured to deny the subsequent block erase commands for one or more block addresses by setting a defined register, and the defined register is associated with a region in the memory that corresponds to the one or more block addresses.

In one example of a computing system, the security management module is further configured to compare the block erase count array to the defined threshold on a per block basis.

In one example of a computing system, the defined threshold is dynamically configured via use of heuristics.

In one example of a computing system, the defined threshold is dynamically configured based on a defined wear out attack pattern or a defined wear out attack vector.

In one example of a computing system, the defined threshold is dynamically configured for specific blocks in the memory based on a risk level of wear out attacks on the specific blocks in the memory.

In one example of a computing system, the defined threshold is dynamically configured based on a current mode of operation for the memory.

In one example of a computing system, the information associated with the erase command includes an erase type and a region number of the memory in which the block erase command occurs.

In one example of a computing system, the store includes a first-in first-out (FIFO) register.

In one example of a computing system, the controller is further configured to store the information associated with the erase command in the store via a finite state machine (FSM).

In one example of a computing system, the controller is further configured to set an erase interrupt threshold register to reduce a number of erase interrupts that are sent from the controller.

In one example of a computing system, the security management module is further configured to clear the block addresses from the store after the block erase count array is updated.

In one example of a computing system, the controller is further configured to erase the data stored in the block of memory in accordance with the block erase command.

In one example of a computing system, the controller is further configured to send an erase interrupt to the security management module after receipt of the block erase command from a processor.

In one example of a computing system, the computing system further comprises a processor configured to send the block erase command to the controller.

In one example of a computing system, the memory is non-volatile memory.

In one example of a computing system, the memory is flash non-volatile memory.

In one example there is provided an apparatus comprising a processor, non-volatile memory, and a controller configured to receive, from the processor, a block erase command to erase data stored in a block of non-memory and to store information associated with the block erase command in a store, where the information includes a block address associated with the data to be erased based on the block erase command. The apparatus further comprises a security management module configured to receive an erase interrupt from the controller, read block addresses from the store upon receipt of the erase interrupt, update a block erase count array stored in the security management module over a defined interval to include block addresses read from the store, and compare the block erase count array to a defined threshold on a per block basis. The security management module is also configured to identify block addresses for which the block erase count array is above the defined threshold and deny subsequent block erase commands for the identified block addresses for a defined period of time to protect the non-volatile memory against memory wear out attacks.

In one example of an apparatus, the security management module is further configured to allow subsequent block erase commands after the defined period of time in accordance with a timer interval counter, and remove one or more block addresses from the block erase count array.

In one example of an apparatus, the security management module is configured to deny the subsequent block erase commands for one or more block addresses by setting a defined register, and the defined register is associated with a region in the non-volatile memory that corresponds to the one or more block address.

In one example of an apparatus, the defined threshold is dynamically configured via use of heuristics, the defined threshold is dynamically configured based on a defined wear out attack pattern or a defined wear out attack vector, the defined threshold is dynamically configured for specific blocks in the non-volatile memory based on a risk level of wear out attacks on the specific blocks in the non-volatile memory, or the defined threshold is dynamically configured based on a current mode of operation for the non-volatile memory.

In one example of an apparatus, the store includes a first-in first-out (FIFO) register.

In one example of an apparatus, the controller is configured to store the information associated with the erase command in the store via a finite state machine (FSM).

In one example of an apparatus, the security management module is configured to clear the block addresses from the store after the block erase count array is updated.

In one example of an apparatus, the controller is configured to send the erase interrupt to the security management module based on the block erase command received from the processor.

In one example there is provided a method comprising receiving, at a security management module from a controller, an erase interrupt when a block erase command is received at the controller for erasing data stored in a block of non-volatile memory, wherein a block address is associated with the data to be erased based on the block erase command, and the block address is stored in a store. The method further comprises reading block addresses from the store upon receiving the erase interrupt, updating a block erase count array stored in the security management module over a defined interval to include block addresses read from the store, comparing the block erase count array to a defined threshold on a per block basis, identifying block addresses for which the block erase count array is above the defined threshold, and denying subsequent block erase commands for the identified block addresses for a defined period of time to protect the non-volatile memory against a memory wear out attack.

In one example of a method, the method further comprises allowing subsequent block erase commands after the defined period of time in accordance with a timer interval counter and removing one or more block addresses from the block erase count array.

In one example of a method, the method further comprises denying the subsequent block erase commands for one or more block addresses by setting a defined register, and the defined register is associated with a region in the non-volatile memory that corresponds to the one or more block address.

In one example of a method, the method further comprises setting the defined threshold based on at least one of: heuristics, a defined wear out attack pattern or a defined wear out attack vector, a risk level of wear out attacks on specific blocks in the non-volatile memory, or a current mode of operation for the non-volatile memory.

In one example of a method, the method further comprises clearing the block addresses from the store after the block erase count array is updated.

In one example of a method, the block erase command is initiated by an attacker attempting to carry out the memory wear out attack against the non-volatile memory.

While the forgoing examples are illustrative of the principles of invention embodiments in one or more particular applications, it will be apparent to those of ordinary skill in the art that numerous modifications in form, usage and details of implementation can be made without the exercise of inventive faculty, and without departing from the principles and concepts of the disclosure.

What is claimed is:

1. A computing system comprising:
memory;
a controller configured to:
receive a block erase command to erase data stored in a block of memory; and
store information associated with the block erase command in a store, wherein the information includes a block address associated with the data to be erased based on the block erase command; and
a security management module configured to:
read block addresses from the store;
update a block erase count array stored in the security management module over a defined interval to include block addresses read from the store;
compare the block erase count array to a defined threshold;
identify block addresses for which the block erase count array is above the defined threshold; and
deny subsequent block erase commands for the identified block addresses to protect the memory against memory wear out attacks.

2. The computing system of claim 1, wherein the security management module is configured to:
allow subsequent block erase commands after a defined period of time in accordance with a timer interval counter; and
remove one or more block addresses from the block erase count array.

3. The computing system of claim 1, wherein the security management module is configured to deny the subsequent block erase commands for one or more block addresses by setting a defined register, and the defined register is associated with a region in the memory that corresponds to the one or more block addresses.

4. The computing system of claim 1, wherein the security management module is configured to compare the block erase count array to the defined threshold on a per block basis.

5. The computing system of claim 1, wherein the defined threshold is dynamically configured using at least one of heuristics, a defined wear out attack pattern, a defined wear out attack vector, a risk level of wear out attacks on specific blocks in the memory, or a current mode of operation of the memory.

6. The computing system of claim 1, wherein the store includes a first-in first-out (FIFO) register.

7. The computing system of claim 1, wherein the controller is configured to store the information associated with the erase command in the store via a finite state machine (FSM).

8. The computing system of claim 1, wherein the controller is configured to set an erase interrupt threshold register to reduce a number of erase interrupts that are sent from the controller.

9. The computing system of claim 1, wherein the security management module is configured to clear the block addresses from the store after the block erase count array is updated.

10. The computing system of claim 1, wherein the controller is configured to send an erase interrupt to the security management module after receipt of the block erase command from a processor.

11. The computing system of claim 1, wherein the memory is non-volatile memory.

12. The computing system of claim 1, wherein the memory is flash non-volatile memory.

13. An apparatus comprising:
a processor;
non-volatile memory;
a controller configured to:
receive, from the processor, a block erase command to erase data stored in a block of non-memory; and
store information associated with the block erase command in a store, wherein the information includes a block address associated with the data to be erased based on the block erase command; and
a security management module configured to:
receive an erase interrupt from the controller;
read block addresses from the store upon receipt of the erase interrupt;
update a block erase count array stored in the security management module over a defined interval to include block addresses read from the store;
compare the block erase count array to a defined threshold on a per block basis;
identify block addresses for which the block erase count array is above the defined threshold; and
deny subsequent block erase commands for the identified block addresses for a defined period of time to protect the non-volatile memory against memory wear out attacks.

14. The apparatus of claim 13, wherein the security management module is configured to:
allow subsequent block erase commands after the defined period of time in accordance with a timer interval counter; and
remove one or more block addresses from the block erase count array.

15. The apparatus of claim 13, wherein the security management module is configured to deny the subsequent block erase commands for one or more block addresses by setting a defined register, and the defined register is associated with a region in the non-volatile memory that corresponds to the one or more block addresses.

16. The apparatus of claim 13, wherein:
the defined threshold is dynamically configured via use of heuristics;
the defined threshold is dynamically configured based on a defined wear out attack pattern or a defined wear out attack vector;
the defined threshold is dynamically configured for specific blocks in the non-volatile memory based on a risk level of wear out attacks on the specific blocks in the non-volatile memory; or
the defined threshold is dynamically configured based on a current mode of operation for the non-volatile memory.

17. The apparatus of claim 13, wherein the store includes a first-in first-out (FIFO) register.

18. The apparatus of claim 13, wherein the controller is configured to store the information associated with the erase command in the store via a finite state machine (FSM).

19. The apparatus of claim 13, wherein the security management module is configured to clear the block addresses from the store after the block erase count array is updated.

20. The apparatus of claim 13, wherein the controller is configured to send the erase interrupt to the security management module based on the block erase command received from the processor.

21. A method comprising:
receiving, at a security management module from a controller, an erase interrupt when a block erase command is received at the controller for erasing data stored in a block of non-volatile memory, wherein a block address is associated with the data to be erased based on the block erase command, and the block address is stored in a store;
reading block addresses from the store upon receiving the erase interrupt;
updating a block erase count array stored in the security management module over a defined interval to include block addresses read from the store;
comparing the block erase count array to a defined threshold on a per block basis;
identifying block addresses for which the block erase count array is above the defined threshold; and
denying subsequent block erase commands for the identified block addresses for a defined period of time to protect the non-volatile memory against a memory wear out attack.

22. The method of claim 21, further comprising:
allowing subsequent block erase commands after the defined period of time in accordance with a timer interval counter; and
removing one or more block addresses from the block erase count array.

23. The method of claim 21, further comprising denying the subsequent block erase commands for one or more block addresses by setting a defined register, and the defined register is associated with a region in the non-volatile memory that corresponds to the one or more block address.

24. The method of claim 21, further comprising setting the defined threshold based on at least one of: heuristics, a defined wear out attack pattern or a defined wear out attack vector, a risk level of wear out attacks on specific blocks in the non-volatile memory, or a current mode of operation for the non-volatile memory.

25. The method of claim 21, further comprising clearing the block addresses from the store after the block erase count array is updated.

26. The method of claim 21, wherein the block erase command is initiated by an attacker attempting to carry out the memory wear out attack against the non-volatile memory.
